(19) United States
(12) Patent Application Publication
(10) Pub. No.: US 2004/0074537 A1
(43) Pub. Date: Apr. 22, 2004

(54) Flow limiting apparatus

(76) Inventor: Christopher Francis Roots, Yeovil (GB)

Correspondence Address: HARRISON & EGBERT, 412 MAIN STREET, 7TH FLOOR, HOUSTON, TX, 77002, US

(21) Appl. No.: 10/451,134

(22) PCT Filed: Dec. 14, 2001
(86) PCT No.: PCT/GB01/05528

(30) Foreign Application Priority Data
Dec. 20, 2000 (GB) 0031006.0

(51) Int. Cl. G05D 7/06

(52) U.S. Cl. 137/487.5

(57) ABSTRACT

A flow limiting apparatus (10′) for limiting the flow of bleed air from an engine includes a plurality of parallel air flow paths therethrough, each flow path being provided by a venturi device (32) having a throat (36) and associated diverging section (37).

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to an apparatus for limiting the flow of bleed air from an engine of an aircraft for use in the aircraft's sub-systems. For example such bleed air may be used for aircraft cabin air conditioning and pressurization, or by an oxygen generating or concentrating apparatus, or for de-icing purposes.

### BACKGROUND OF THE INVENTION

It is desirable to use a flow limiting apparatus in such circumstances in order to maintain the air pressure and to enhance fuel efficiency.

Such a flow limiting apparatus typically includes a venturi device which has a converging section, a throat, and a diverging section. To achieve smooth fluid flow with a minimum of fluid turbulence, the length of the diverging section is dependant upon the diameter of the throat, with the diverging section being relatively long. For example, for a typical engine air bleed flow limiting apparatus in which the throat has a diameter of about 25 mm, the diverging section may have a length of about 200 mm, with a cone angle of the diverging section of about 14°.

Providing a flow limiting apparatus with a long diverging section, and thus long overall length is acceptable in many applications, where space permits, but particularly in some aircraft where space is at a premium, for example where the distance between an engine bleed port and an engine nacelle in an aircraft engine installation, is too short, it may not be possible to accommodate such a long length venturi device. In such circumstances, typically a flow limiting apparatus having a simple orifice has to be provided, resulting in unwanted turbulence, accordingly high fluid pressure losses, and attendant higher fuel consumption.

Another reason for minimizing pressure losses due to the flow limiting apparatus is that where the bleed air is used for air conditioning, after processing the bleed air, the bleed air is expanded by passing the bleed air through a turbine wheel. The greater the pressure of the bleed air, the greater the pressure and thus temperature drop can be achieved, resulting in greater and more efficient cooling of the bleed air.

### BRIEF SUMMARY OF THE INVENTION

According to a first aspect of the invention we provide an apparatus for limiting the flow of bleed air from an engine, the apparatus includes a plurality of parallel fluid flow paths therethrough, each flow path being provided by a venturi device having a throat and associated diverging section.

Thus by providing a plurality of parallel fluid flow paths, with the diameter of each throat being smaller than that which would be required for a single venturi device whilst together providing at least an equivalent area for fluid flow as a single venturi device, it has been found that a desired limited air flow may be achieved through the apparatus, with a loss of pressure which is at least not substantially greater, and possibly less, than for an equivalent single venturi device. Importantly, the overall length of the apparatus may be made considerably shorter than for an equivalent single venturi device, whilst a cone angle of the diverging section may still be made to be about 14°.

Because the flow limiting apparatus may be made shorter than a conventional such apparatus, the apparatus may be situated where most convenient, e.g. either at or adjacent a port through which engine bleed air passes from the engine, or in ducting from the port.

Preferably the plurality of venturi devices are arranged in a generally circular array, with the throat of each venturi device centered generally on a circle, and the array may include a central venturi device, with the throat of the central venturi device centrally located of the circle.

Preferably each of the plurality of venturi devices includes a converging section.

The multiple venturi devices of the flow limiting apparatus may be contained within a generally cylindrical body.

If desired, the flow control apparatus may include means to monitor and/or regulate the flow of fluid through the apparatus.

To achieve this a fluid signal may be derived from the apparatus, and converted to an electrical signal using a suitable transducer, which electrical signal may be used to give an indication of fluid flow, or to regulate fluid flow.

The electrical signal may be used to operate a controller which is operative to regulate air flow through the apparatus.

Alternately, the monitoring and/or regulating means may be operated in response to an air signal.

Preferably, the air signal is derived from a plurality of or all of the fluid flow paths, for example by providing passages from the flow paths, in the region of the respective venturi device, and connecting the passages to so that the transducer receives a compound air signal.

Whereas it is previously known to monitor air flow through prior art devices in a similar manner to that described, by virtue of the invention, the overall length of the apparatus may again be minimized by virtue of the plurality of parallel venturis.

According to a second aspect of the invention we provide an engine installation including a chamber having therein, high pressure air, and an apparatus to limit the flow of bleed air from the chamber, for use, the apparatus providing a plurality of parallel fluid flow paths therethrough, each flow path being provided by a venturi device having a throat and associated diverging section.

The flow limiting apparatus may be positioned at or adjacent bleed port from the chamber, or in ducting, extending from the port.

According to a third aspect of the invention we provide an aircraft having an engine installation according to the second aspect of the invention.

The aircraft may include a sub-system being one or more of the following, to which bleed air is fed for use, namely, an air conditioning sub-system, a cabin air pressurization sub-system, an oxygen generating or concentrating sub-system, and a de-icing sub-system.

According to a fourth aspect of the invention we provide a method of bleeding air from a high pressure port for subsequent use, including the step of passing the air through a flow control apparatus according to the first aspect of the invention.

The method may include deriving from at least one and preferably a plurality of the parallel air flow paths, an air signal, converting the air signal into an electrical signal which may be used to give an indication of, or to operate a controller which is operated to regulate, air flow through the apparatus.

### BRIEF DESCRIPTION OF THE SEVERAL VIEWS OF THE DRAWINGS

The invention will now be described with reference to the accompanying drawings in which:

FIG. 1 is an illustrative view of part of a prior art engine installation incorporating a prior art venturi device.

FIG. 2 an illustrative view of part of a prior art, single venturi device.

FIG. 3 is a view of an engine installation similar to FIG. 1 but incorporating a flow limiting apparatus in accordance with the invention.

FIG. 4 is an end view of a flow limiting apparatus in accordance with the invention.

FIG. 5 is a side cross-sectional view taken on the lines A-A of FIG. 4.

FIG. 6a and 6b are respectively side and end views of an apparatus in accordance with the invention, with a flow monitor/control means.

FIG. 7 is an illustrative view of an aircraft having an engine installation incorporating the invention.

### DETAILED DESCRIPTION OF THE INVENTION

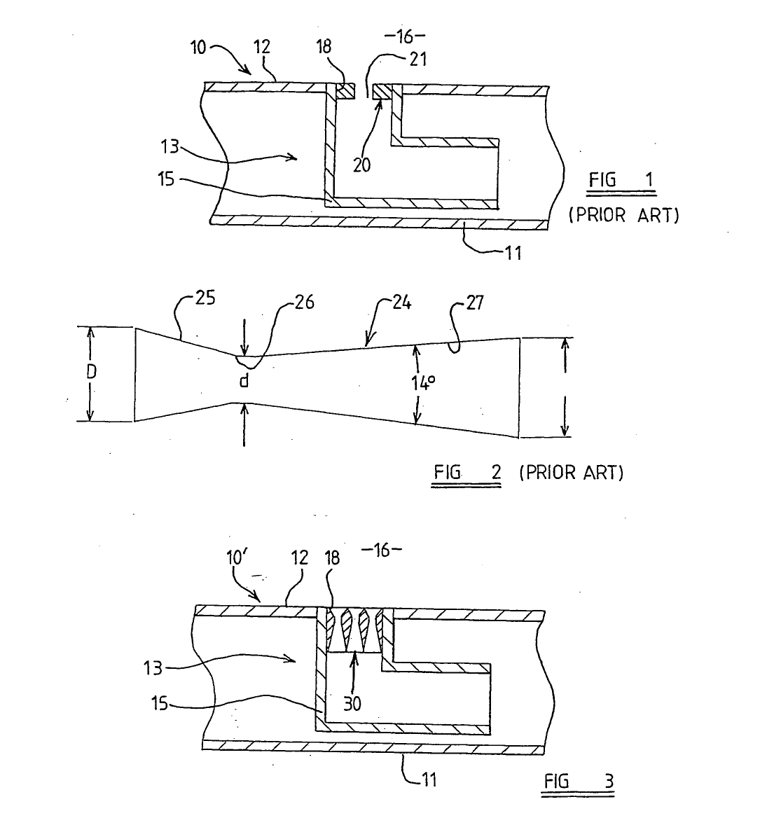

Referring to FIG. 1, an engine installation 10 of an aircraft includes an outer engine casing 11, an inner engine casing 12, and a space 13 between the inner 12 and outer 13 engine casings. Within the space 13 there is ducting 15 for engine air bled from a high air pressure chamber 16 of the engine installation 10, which air may be bled from the chamber 16 through a bleed port indicated at 18. To limit the flow of air through the port 18 there is provided a flow limiting apparatus 20 which in this case is a simple orifice 21, sized to restrict the air flow to a desired degree. However the simple orifice 21 results in considerable turbulence in the ducting 15, which is undesirable, and the flow limiting apparatus 20 of this figure, results in pressure losses which are greater than desirable.

In FIG. 2 there is shown a single venturi device 24 which may be used as a flow limiting apparatus in the place of the flow limiting apparatus 20 shown in FIG. 1, where space permits this. It can be seen that overall, the venturi device 24 is substantially longer than the flow limiting apparatus 20 of FIG. 1, and includes a converging section 25, a throat 26 through which the air is constrained to flow, and a diverging section 27 which is substantially conical in configuration and includes a cone angle of about 14°.

The venturi device 24 necessarily is long because the length of the diverging section 27 is related to the diameter d of the throat 26, and the cone angle is ideally of about 14°.

Thus where the bleed port 18 has a diameter D, so the inlet of converging section 25 has a diameter of about D, the throat 26 limits air flow, whilst minimal pressure losses are incurred due to the air flowing smoothly, generally without turbulence, along the diverging section 27.

It will be appreciated that in the FIG. 1 engine installation, the ducting 15 between the inner 12 and outer 13 engine casings is insufficiently long readily to accommodate the single venturi device 24 of FIG. 2 and thus the advantages of providing a venturi device, such as shown in FIG. 2, hithertofore, have not been realizable.

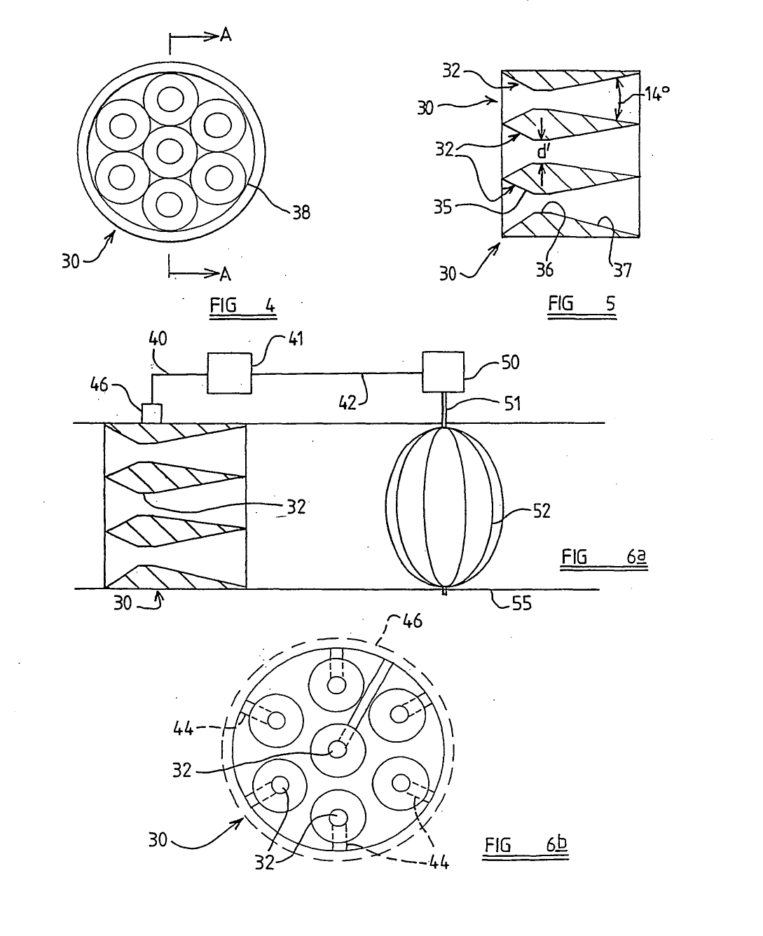

Referring now to FIGS. 3, 4, 5 and 7 there is shown an engine installation 10′ for an aircraft A, in accordance with the second aspect of the invention. Similar parts to those shown in FIG. 1 are indicated by the same reference numerals.

In the FIG. 3 installation 10′, the simple orifice type of flow limiting apparatus 20 is replaced with a flow limiting apparatus 30 in accordance with the first aspect of the invention.

The flow limiting apparatus 30 of the invention provides a plurality of parallel air flow paths therethrough, in this example seven air flow paths, each air flow path including a venturi device 32 of substantially identical construction. Each venturi device 32 includes a converging section 35, a throat 36, and a diverging section 37. The diameters d′ of the throats 36 are commensurately smaller than the diameter d of the single venturi device 24 of FIG. 2, the total cross-sectional area of the seven throats being about the same as the cross sectional area of a throat of a corresponding single venturi device 24, but the converging sections 35 and importantly diverging sections 37, are substantially shorter than the converging 25 and diverging 36 sections of the corresponding single venturi device 24. Moreover, the cone angles of each diverging section 37 of each venturi device 32 are maintained at about 14°.

Thus overall, the multiple venturi device flow limiting apparatus 30 is substantially shorter than a corresponding single venturi device 24, without there being any substantially greater pressure loss in the flowing air.

In this example, the multiple (seven) venturi devices 32 are housed in a circular body 38 which can be set in the bleed port 18 e.g. in the place of the simple orifice type flow limiting device 20 of FIG. 1. Thus six of the venturi devices 32 are arranged so as to be centered on a circle, with the seventh venturi device 32 located centrally of the body 38. Of course other arrangements are possible depending on the available space etc. Instead of providing the flow limiting apparatus 30 at or adjacent the bleed port 18, in another arrangement the apparatus 30 may be positioned along the ducting 15 in another convenient location.

In each case, air flowing through the multiple flow paths of the apparatus 30, i.e., through the throats 36 of the multiple venturi devices 32 may be fed for use in an aircraft sub-system such as an air-conditioning or air pressurization sub-system, or an oxygen generator or concentrator, or even a de-icing sub-system. Particularly where the air is for use in air conditioning, the minimal loss of pressure sustained enables the air more effectively to be cooled before being fed into an aircraft cabin for example. Where the air is to be used by an oxygen generating or concentrating system, the minimal pressure losses enable oxygen to be produced, or oxygen concentration to be enhanced more effectively than with a simple orifice apparatus such as indicated at 20 in FIG. 1, where there is insufficient space to accommodate a single venturi device 24 of the kind shown in FIG. 2.

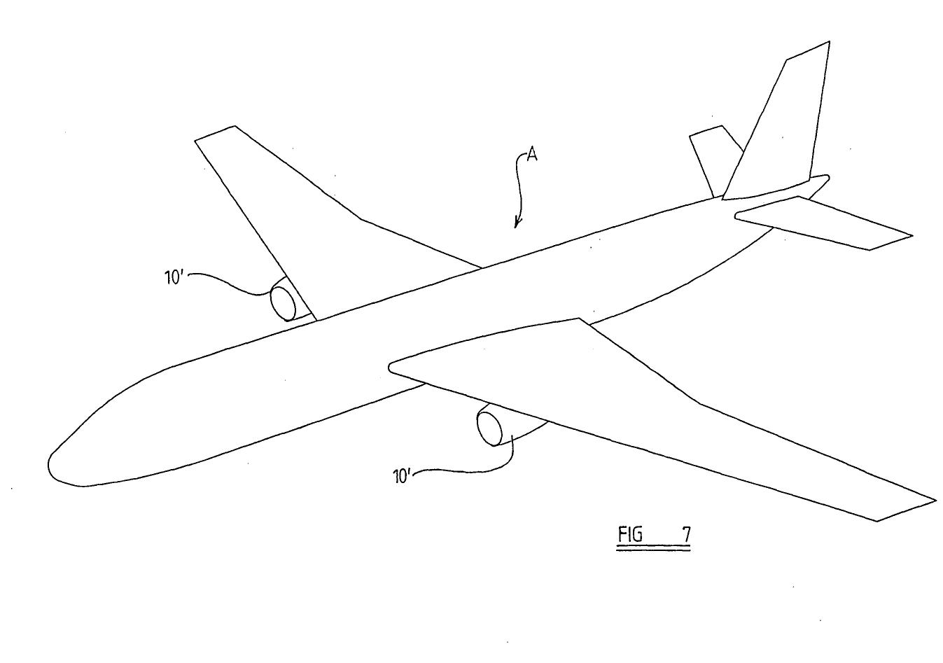

Referring now to FIGS. 6a and 6b, a flow control apparatus 30 similar to that of FIGS. 3 to 5 is shown, but modified. Similar parts to those indicated in FIGS. 3 to 5 are labeled with the same reference numbers.

In this embodiment, an air signal is derived from the air flow apparatus 30, and fed along a line 40 to a transducer 41 which converts the air signal to an electrical signal on line 42. For example, the magnitude of or. other characteristic of the electrical signal may depend on the pressure of the air of the air signal, but could depend on the air flow speed, where an air flow sensor is provided to generate the air signal.

The air signal is derived from respective passages 44 which connect with the fluid flow, in the regions of the venturis 32. In the example shown, a passage 44 is provided for each venturi 32, and the passages 44 are all connected, e.g. via a manifold 46 to the line 40 so that the air signal received by the transducer 41 is a compound signal.

In another example, the air signal may not be derived from all of the venturis 32, but only one of them, or from a plurality of them.

The electrical signal 42 is in this example, used to regulate the air flow through the apparatus 30. The signal is fed to a controller 50 which may include motive means, to turn a shaft 51 which is connected to a butterfly valve 52 in a bleed passage 55 downstream of the flow limiting apparatus 30. Of course, any alternative air flow regulating means may be provided, and/or the electrical signal may be used for indicating air flow through the flow limiting apparatus 30, if desired.

Instead of using an electrical signal to operate a flow limiting apparatus 30, an air signal may be used, e.g. via Servo, to operate an actuator such as a piston and cylinder device, which operates a valve in the bleed passage 55, to regulate air flow.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

I claim:

1. An apparatus for limiting the flow of bleed air from an engine, the apparatus including a plurality of parallel air flow paths therethrough, each flow path being provided by a venturi device having a throat and associated diverging section.

2. An apparatus according to claim 1 characterized in that a cone angle of the diverging section of each of the plurality of venturi devices is about 14°.

3. An apparatus according to claim 1 or claim 2 characterized in that the plurality of venturi devices are arranged in a generally circular array.

4. An apparatus according to claim 3 characterized in that the throat of each venturi device is centered generally on a circle with there being a central venturi device, with the throat of the central venturi device centrally located of the circle.

5. An apparatus according to any one of the preceding claims characterized in that each of the plurality of venturi devices includes a converging section.

6. An apparatus according to any one of the preceding claims characterized in that the multiple venturi devices of the flow limiting apparatus are contained within a generally cylindrical body.

7. An apparatus according to any one of the proceeding claims, characterized in that means are provided to monitor and/or regulate the flow of air through the apparatus.

8. An apparatus according to claim 7 characterized in that the monitoring and/or regulating means include a transducer to which an air signal derived from the apparatus is fed, the transducer converting the air signal into an electrical signal.

9. An apparatus according to claim 8 characterized in that the electrical signal operates a controller which regulates fluid flow through the apparatus.

10. An apparatus according to claim 7 characterized in that the monitoring and/or regulating means is operated in response to an air signal derived from the apparatus.

11. An apparatus according to claim 8 or claim 9 or claim 10 characterized in that the air signal is derived from a plurality of the fluid flow paths via passages from the flow paths in the regions of the respective venturi devices, the passages being connected so that the transducer receives a compound air signal.

12. An engine installation including a chamber having therein, high pressure air, and an apparatus to limit the flow of bleed air from the chamber for use, the apparatus providing a plurality of parallel fluid flow paths therethrough, each flow path being provided by a venturi device having a throat and associated diverging section.

13. An installation according to claim 12 characterized in that the flow limiting apparatus is positioned at or adjacent a bleed port from the chamber.

14. An installation according to claim 14 characterized in that the flow limiting apparatus is positioned in ducting extending from the bleed port.

15. An aircraft having an engine installation according to any one of claims 12 to 14.

16. An aircraft according to claim 15 characterized in that the aircraft includes at a sub-system being one or more of the following, to which bleed air is fed for use, namely, an air conditioning sub-system, a cabin air pressurization sub-system, an oxygen generating or concentrating sub-system, and a de-icing sub-system.

17. A method of bleeding air from a high pressure port for subsequent use, including the step of passing air through a flow limiting apparatus according to any one of claims 1 to 11.

18. A method according to claim 17 characterized in that the method includes deriving from at least one of the plurality of parallel air flow paths of the flow control apparatus, an air signal, and using the air signal to give an indication of, and/or to operate a controller which is operative to regulate, air flow through the apparatus.
